(19) United States
(12) Patent Application Publication
(10) Pub. No.: US 2006/0000821 A1
(43) Pub. Date: Jan. 5, 2006

(54) Oven with a system for generating steam

(76) Inventors: Davide Gerola, Varese (IT); Massimiliano Comolli, Varese (IT); Rocco Galli, Travedona Monate (IT)

Correspondence Address: WHIRLPOOL PATENTS COMPANY - MD 0750, 500 RENAISSANCE DRIVE - SUITE 102, ST. JOSEPH, MI, 49085, US

(21) Appl. No.: 11/172,307

(22) Filed: Jun. 30, 2005

(30) Foreign Application Priority Data
Jun. 30, 2004 (IT) MI2004U000319

(51) Int. Cl. A21B 1/22

(52) U.S. Cl. 219/401

(57) ABSTRACT

An oven comprises a housing defining a cooking cavity, a steam generator defining a chamber and having an evaporation element located in the chamber for generating steam that is introduced into the cooking cavity, and a water reservoir in fluid communication with the chamber and positioned relative to the chamber to supply water to the chamber to at least a minimum level at which the water completely immerses the evaporation element. Further, the steam generator can have a top defining an upper extent of the chamber, and the water reservoir can have a top positioned relative to the chamber such that the water reservoir top is vertically below the steam generator top.

### BACKGROUND OF THE INVENTION

1. Field of the Invention

The invention relates to an oven with a system for generating steam.

2. Description of the Related Art

Both from literature and from tests, it is known that the use of steam in an oven during cooking positively influences the quality of the prepared food. For this reason, ovens have been constructed comprising in their cooking chamber the usual heating elements (for browning and heating with or without forced air circulation) and provided additionally with means for generating steam or for combining steam generation with hot air circulation. The steam can be fed to the cooking chamber either with or without activating the heating elements.

In the known art, devices generating steam for domestic use in ovens comprise a boiler with a heating element which, when immersed in water, heats the water to generate steam, which is then fed into the cooking chamber and used to cook food. These known systems suffer from the problem of water depletion in the boiler, which can lead to overheating and damaging the heating element. On the other hand, when there is an excessive amount of water in the boiler, energy is wasted by having to heat a large quantity of water when used to feed a relatively small amount of steam into the cooking chamber.

### SUMMARY OF THE INVENTION

An oven according to one embodiment of the invention comprises a housing defining a cooking cavity, a steam generator defining a chamber and having an evaporation element located in the chamber for generating steam that is introduced into the cooking cavity, and a water reservoir in fluid communication with the chamber and positioned relative to the chamber to supply water to the chamber to at least a minimum level at which the water completely immerses the evaporation element.

The water reservoir can further comprise a water level sensor to sense a level of water in the water reservoir. The water level sensor can comprise a first water level sensor that senses a maximum level of water in the water reservoir and a second water level sensor that senses a minimum level of water in the water reservoir. The oven can further comprise a signal generator operable to communicate the user the sensed level of water in the water reservoir. The water level sensor can be operably coupled to the evaporation element to control activation and deactivation of the heating element in response to the sensed level of water in the water reservoir.

The water reservoir can comprise a base and can be positioned relative to the chamber with at least a portion of the base vertically higher than the evaporation element. The entire base can be vertically higher than the evaporation element. The water reservoir can comprise an outlet in the base, and the outlet can be vertically higher than the evaporation element.

A capacity of the water reservoir can be greater than a capacity of the chamber.

A level of water in the chamber can be the same as a level of water in the water reservoir. A minimum level of water in the water reservoir can be the same as or higher than the minimum level of water in the steam generator. A maximum level of water in the water reservoir can be the same as or less than a maximum level of water in the steam generator.

The oven can further comprise a temperature sensor in the steam generator to sense a parameter representative of a temperature of the water in chamber. The parameter can be the temperature of the water in the chamber.

The oven can further comprise a discharge valve near an outlet of the steam generator to drain water from the chamber.

The oven can further comprise an inlet valve near an inlet to the water reservoir to control the supply of water to the water reservoir.

The oven according can further comprise a heating system to heat the cooking cavity.

The steam generator can have a top defining an upper extent of the chamber, and the water reservoir can have a top positioned relative to the chamber such that the water reservoir top is vertically below the steam generator top.

An oven according to another embodiment of the invention comprises a housing defining a cooking cavity, a steam generator having a top defining an upper extent of a chamber, and a water reservoir having a top and in fluid communication with the chamber to supply water to the chamber and positioned relative to the chamber such that the water reservoir top is vertically below the steam generator top.

A level of water in the chamber can be the same as a level of water in the water reservoir. A capacity of the water reservoir can be greater than a capacity of the chamber.

### BRIEF DESCRIPTION OF THE DRAWING

In the drawings:

FIG. 1 is a perspective view of an exemplary automatic household oven.

FIG. 2 is a schematic view of the oven of FIG. 1.

FIG. 3 is a schematic diagram illustrating a control system of the oven of FIG. 1.

FIG. 4 is a schematic view of a system according to one embodiment of the invention for generating steam for use with the oven of FIG. 1.

### DESCRIPTION OF EMBODIMENTS OF THE INVENTION

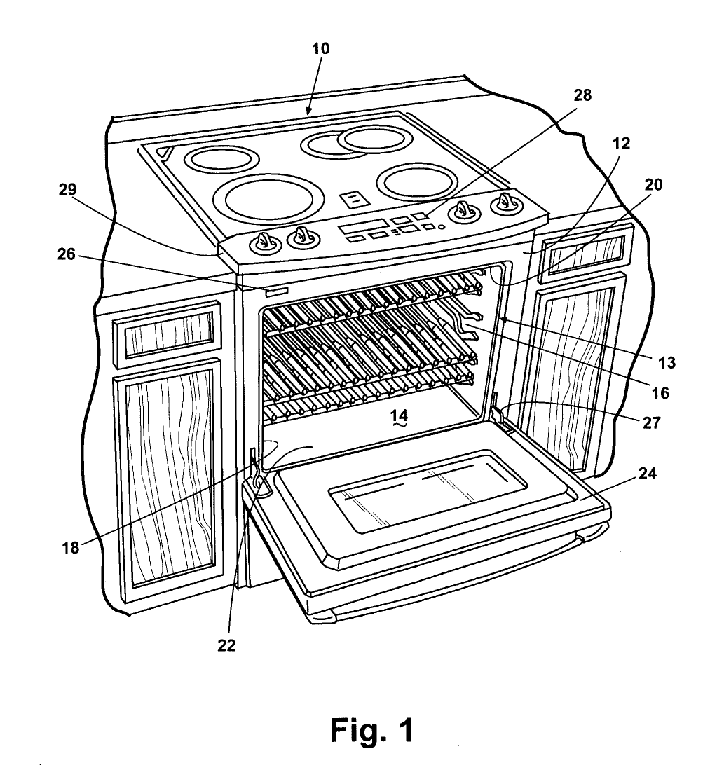

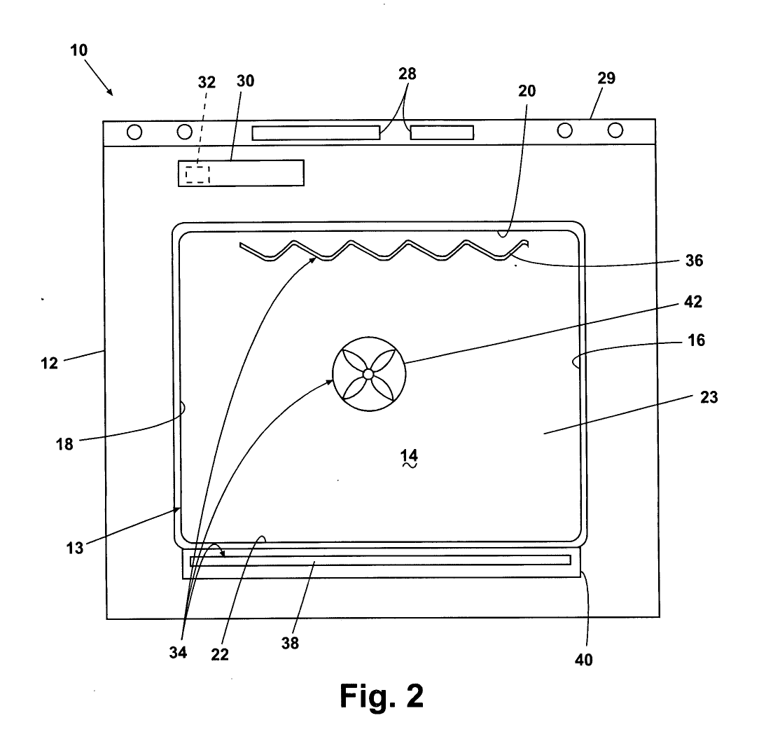

Referring now to the figures, FIG. 1 illustrates an exemplary automatic household oven 10 that can be equipped with a steam system according to one embodiment of the invention. The oven 10 comprises a cabinet 12 with an open-face housing 13 having a pair of spaced side walls 16, 18 joined by a top wall 20, a bottom wall 22, and a rear wall 23 (FIG. 2) to define an open-face cooking cavity 14. A door 24 pivotable at a hinge 27 selectively closes the cavity 14, and a sensor 26 detects an open position of the door 24 and a closed position of the door 24. When the door 24 is in the open position, a user can access the cavity 14, while the door 24 in the closed position prevents access to the cavity 14 and seals the cavity 14 from the external environment.

The oven 10 further comprises a console 29 with a control panel 28 having a user interface accessible to the user for inputting desired cooking parameters, such as temperature and time, of manual cooking cycles or for selecting automated cooking cycles. The user interface can comprise, for example, a push button, a rotatable knob, a touch pad, a touch screen, or a voice command unit. The control panel 28 communicates with a controller 30 located in the cabinet 12, as shown in FIG. 2. The controller 30 can be a proportional-integral-derivative (PID) controller or any other suitable controller, as is well-known in the automatic oven art. The controller 30 stores data, such as default cooking parameters, the manually input cooking parameters, and programs for the automated cooking cycles, receives input from the control panel 28, and sends output to the control panel 28 for displaying a status of the oven 10 or otherwise communicating with the user. Additionally, the controller 30 includes a timer 32 for tracking time during the manual and automated cooking cycles.

With continued reference to FIG. 2, the oven 10 further comprises a heating system 34 having an upper heating element 36, commonly referred to as a broiler, and a lower heating element 38. The schematic illustration of FIG. 2 shows the lower heating element 38 as being hidden or mounted beneath the cooking cavity bottom wall 22 in a heating element housing 40. Heat from the lower heating element 38 conducts through the bottom wall 22 and into the cavity 14. Alternatively, the lower heating element 38 can be mounted inside the cavity 14, as is well-known in the oven art. Further, the upper and lower heating elements 36, 38 can be mounted at the side walls 16, 18 of the cavity 14, as disclosed in U.S. Pat. No. 6,545,251 to Allera et al., which is incorporated herein by reference in its entirety. The heating system 34 according to the illustrated embodiment further comprises a convection fan 42 that circulates air and steam, when present, within the cavity 14. The convection fan 42 can be any suitable fan and can be mounted in any suitable location of the cavity 14, such as in the rear wall 23. The particular type of heating system is not germane to the invention; the heating system 34 shown and described herein is for illustrative purposes only and is not meant to limit the invention in any manner.

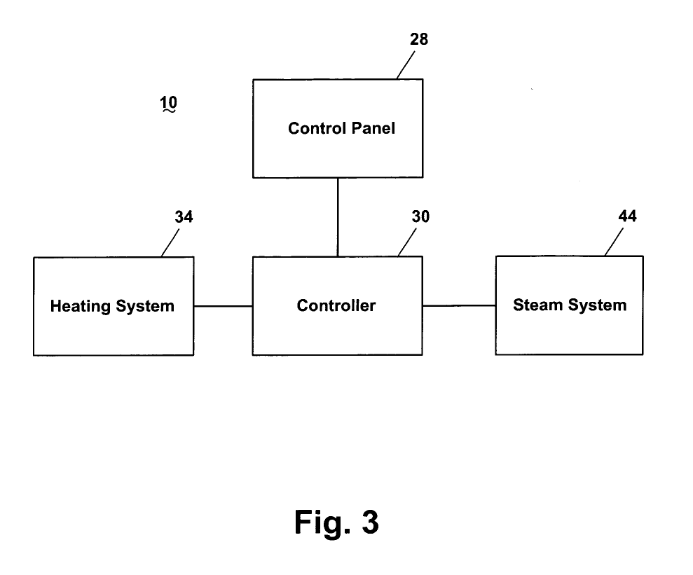

FIG. 3 is a block diagram that schematically illustrates a control system of the oven 10. The control system comprises the controller 30, which operably communicates with the control panel 28, as described above, the heating system 34, and a steam system 44. The controller 30 instructs the heating system 34 to activate or deactivate the upper heating element 36, the lower heating element 38, and the convection fan 42, either all together, individually, or in groups, and provides instructions regarding the desired temperature of the cavity 14 and the rate at which the heating system 34 heats the cavity 14. Similarly, the controller 30 instructs the steam system 44 to activate or deactivate to provide to the cavity 14 a desired amount of steam at a desired steam generation rate corresponding to a desired relative humidity in the cavity 14.

Ovens having a heating system 34 and a steam system 44 are commonly referred to as combi ovens. The heating system 34 can be employed alone, as in a traditional oven, or in combination with the steam system 44. When both the heating system 34 and the steam system 44 are utilized, the steam system 44 functions as a support or accessory for the heating system 34. Alternatively, the steam system 44 can be used alone for cooking with steam only.

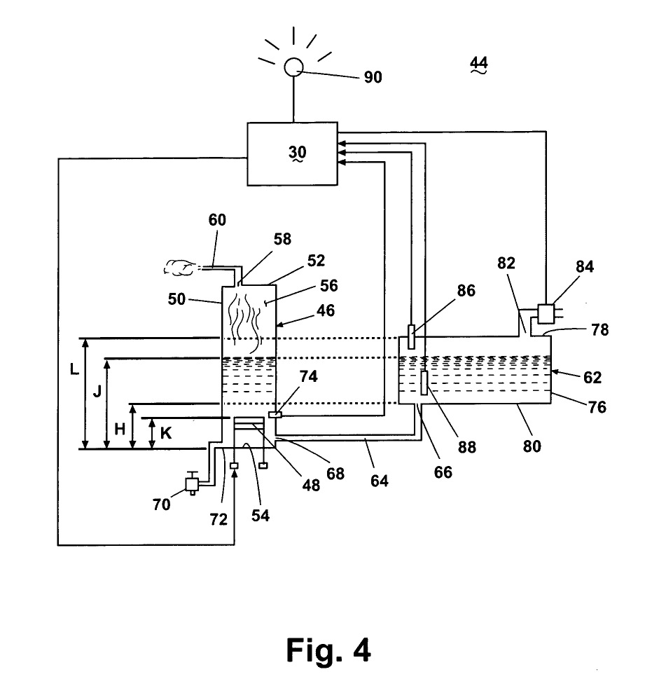

The steam system 44 according to one embodiment of the invention is illustrated schematically in FIG. 4 and comprises a boiler or steam generator 46 in which an evaporation element 48, such as a resistive heating element, is disposed. The steam generator has a peripheral wall 50 closed at an upper end by a top 52 and at lower end by a bottom or base 54, and the peripheral wall 50, the top 52, and the base 54 define a chamber 56. In the top 52 of the steam generator 46, a steam exit aperture or outlet 58 is provided, to which a conduit 60 is connected to transfer the steam generated in the steam generator 46 to the cooking chamber 14. A water reservoir 62 is connected to the steam generator 46 via a pipe or conduit 64 to supply water to the steam generator 46 between an outlet 66 of the water reservoir 62 and an inlet 68 of the steam generator 46, and a discharge valve 70 is connected near an outlet 72 of the steam generator 46 for emptying the water from the steam generator 46 through the outlet 72, for example when the steam system 44 is to remain unused for lengthy periods.

The steam system 44 further comprises a temperature sensor 74 for sensing a parameter representative of a temperature of the water in the steam generator 46, which can include a direct or indirect sensing of the temperature of the water in the chamber 56 of the steam generator 46. Direct sensing includes directly sensing the water. Indirect sensing includes sensing the temperature of an item, such as the peripheral wall 50, having a known or determinable relationship with the temperature of the water. The temperature sensor 74 can be positioned in any suitable location to sense the parameter. For example, the temperature sensor 74 can be mounted to the steam generator 46 in direct contact with the water in the chamber 56 of the steam generator 46, embedded in one of the walls 50, 52, 54 of the steam generator 46 to encase and protect the temperature sensor 74, or attached to an exterior surface of the steam generator 46. According to the illustrated embodiment, the temperature sensor 74 is vertically positioned at or below a level H, or a minimum level of water acceptable in the steam generator 46, to ensure that the temperature sensor 74 is able to sense the temperature of the water. The temperature sensor 74 can be any suitable type of sensor, including, but not limited to, thermocouples, ceramic thermistors, metallic resistance temperature devices (RTDs), and infrared temperature measurement devices.

As stated above, the reference letter H indicates the minimum level of water acceptable in the steam generator 46, and the reference letter K indicates a height of the evaporation element 48 measured from the base 54 of the steam generator 46. In order for the system to function, the pressure drop through the exit aperture 52 must not exceed the pressure produced by a column of water of height H-K, which corresponds to the minimum height of water present at the top of the evaporation element 48. This can be achieved by connecting a known nozzle of suitable dimensions to the exit aperture 58.

The pipe 64 connects the steam generator 46 to the reservoir 62, which has much larger dimensions and hence volume or capacity than the steam generator 46. The reservoir 62 comprises a peripheral wall 76 closed at an upper end by a top 78 and at a bottom end by a bottom or base 80. An access or inlet 82 for feed water entry into the reservoir 62 is provided in the top 78 of the reservoir 62 or in any other suitable location of the reservoir 62. An inlet valve 84 upstream from the access 82 is operable to close feed water entry when the reservoir 62 is sufficiently full. The reservoir 62 includes a reservoir water level sensor, which, according to the illustrated embodiment, comprises a first level sensor 86 and a second level sensor 88. The first level sensor 86 detects the attainment of a maximum water level in the reservoir 62, and the second level sensor 88 detects the attainment of a minimum water level in the reservoir 62. However, it is within the scope of the invention for the water reservoir 62 to include one or more than two water level sensors. For example, the water reservoir 62 can comprise three water level sensors: a low water level sensor to sense when the water level is too low, a high water level sensor to sense when the water level is sufficiently high, and a water level sensor between the low and high water level sensors that senses when the water level is approaching the lower water level sensor to warn the user that the reservoir 62 will need to be filled soon.

As stated previously, the steam system 44 operably communicates with the controller 30. Data from the level sensors 86, 88 and the temperature signal generated by the temperature sensor 74 are fed to the controller 30. Additionally, the controller 30 communicates with the evaporation element 48 to activate or deactivate the evaporation element 48 to achieve or maintain a desired temperature of the water in the steam generator 46 according to a manual or automatic cooking cycle. The controller 30 is also operably coupled with the control panel 28 for activating or deactivating a suitable signal generator 90, such as a light and/or acoustic signal generator, associated with the control panel 28 to communicate to the user the level of water in the reservoir 62. For the illustrated embodiment, the signal generator 90 can indicate that the water level in the reservoir 62 is too low or sufficiently high.

By the principle of communicating vessels, the water level in the reservoir 62 and in the chamber 56 of the steam generator 46 is substantially the same. For example, as shown in FIG. 4, the level of water in the reservoir 62 is indicated by the letter J, and the water level J is the same as the level of water in the chamber 56. As used herein, the “level” of water corresponds to a height of water relative to a common reference. Thus, two vessels having the same level of water, such as the water level J, need not hold the same volume of water.

For the evaporation element 48 to always remain completely immersed in or covered with water during operation to prevent overheating with consequent possible burning of the evaporation element 48, the water level in the steam generator 46 must be sufficiently high. For this reason, at least a portion of the base or bottom wall 80 of the reservoir 62 is positioned at a higher level than the level K attained by the evaporation element 48, i.e. at the aforesaid level H in FIG. 4. Additionally, the outlet 66 of the water reservoir 62 is preferably vertically above the inlet 68 to the steam generator 46. The level H must also not be too high to prevent water filling the entire volume of the steam generator 46 and entering the cooking chamber 14 together with the generated steam. As used herein, “completely immerse” refers to a condition wherein substantially all exterior surfaces of the evaporation element 48 in the steam generator 46 are covered by or in contact with water most of the time. It is within the scope of the invention for some exterior surfaces of the immersed evaporation element 48 to intermittently be exposed, such as a result of turbulence caused by boiling water in the steam generator 46. Thus, “completely immerse” is not limited to all exterior surfaces of the evaporation element 48 being covered by or in contact with water all of the time.

Because of the communicating vessels, the water level in the reservoir 62 when the reservoir 62 is substantially full (i.e., water level in the reservoir 62 is at a maximum water level), determines a maximum water level L in the chamber 56. Thus, the water reservoir 62 is preferably positioned and sized so that an upper extent of the reservoir 62, which is defined by the top 78 in the illustrated embodiment, corresponds to or is lower than a maximum water level L acceptable in the steam generator 46. Furthermore, the maximum water level in the reservoir 62 and, thus, the maximum water level L acceptable in the steam generator 46, preferably correspond to a relatively small volume of water in the chamber 56. As a result, the evaporation element 48 can efficiently and quickly heat the relatively small volume of water in the chamber 56.

In operation, the feed water is supplied to the steam system 44 through the inlet valve 84 and the access 82 of the reservoir 62. A system can be provided by which water is manually added to the reservoir 62, or, alternatively, water can be supplied by an automated system directly connected to the water main. In the latter case, the controller 30 can control the flow of water from the water main into the reservoir 62 by opening and closing the inlet valve 84. Water from the reservoir 62 is then fed through the pipe 64 into the chamber 56 of the steam generator 46 at least until the water completely immerses or covers the evaporation element 48. By the principle of communicating vessels, the water level in the reservoir 62 and in the steam generator 46 is the same, as shown by the water level J in FIG. 4; hence, there is no need for pumps for transferring water from the reservoir 62 to the steam generator 46.

The relatively small quantity of water present in the steam generator 46 enables the evaporation element 48 to rapidly heat the water and produce steam. Additionally, the temperature sensor 74 feeds to the controller 30 a temperature signal, which is useful, for example, if the water in the steam generator 46 is to be preheated so that steam can be introduced rapidly into the cooking cavity 14 when required by the manual or automatic cooking cycle. Moreover, as the water levels in the chamber 56 of the steam generator 46 and the water reservoir 62 are substantially the same, as shown in FIG. 4, and the base 80 of the reservoir 62 is at a higher level than the evaporation element 48, the evaporation element 48 always remains covered with water in the steam generator 46, even with a small water quantity in the reservoir 62.

When the water level falls to the minimum allowable level in the reservoir 62, such as due to steam generation or water evaporation in the steam generator 46, the second level sensor 88 feeds a signal to the controller 30, which deactivates the evaporation element 48 and, depending on preference, either emits a signal via the signal generator 90 so that the user is aware to fill the water reservoir 62 and/or automatically opens the inlet valve 84 to again feed water into the steam system 44. By eliminating power to the evaporation element 48, the evaporation element 48 does not remain in an active condition while being exposed (i.e., not completely immersed in the water), which prevents overheating of the evaporation element 48.

When the water level reaches maximum level in the water reservoir 62 during filling of the water reservoir 62, the first level sensor 86 feeds a signal to the controller 30 which, depending on preference, either emits a signal via the signal generator 90 so that the user is aware that water reservoir 62 is full and/or instructs the inlet valve 84 to close and prevent water flow to the water reservoir 62.

Because the water reservoir 62 is separate from but connected to the steam generator 46, the second level sensor 88 can be disposed in the water reservoir 62 instead of in the steam generator 46. If such a level sensor were disposed in the steam generator 46, the sensor would not give reliable results because, for example, the sensor would be subjected to turbulence of the boiling water.

While the invention has been specifically described in connection with certain specific embodiments thereof, it is to be understood that this is by way of illustration and not of limitation, and the scope of the appended claims should be construed as broadly as the prior art will permit.

What is claimed is:

1. An oven comprising:
a housing defining a cooking cavity;
a steam generator defining a chamber and having an evaporation element located in the chamber for generating steam that is introduced into the cooking cavity; and
a water reservoir in fluid communication with the chamber and positioned relative to the chamber to supply water to the chamber to at least a minimum level at which the water completely immerses the evaporation element.

2. The oven according to claim 1, wherein the water reservoir further comprises a water level sensor to sense a level of water in the water reservoir.

3. The oven according to claim 2, wherein the water level sensor comprises a first water level sensor that senses a maximum level of water in the water reservoir and a second water level sensor that senses a minimum level of water in the water reservoir.

4. The oven according to claim 2 and further comprising a signal generator operable to communicate the user the sensed level of water in the water reservoir.

5. The oven according to claim 2, wherein the water level sensor is operably coupled to the evaporation element to control activation and deactivation of the heating element in response to the sensed level of water in the water reservoir.

6. The oven according to claim 1, wherein the water reservoir comprises a base and is positioned relative to the chamber with at least a portion of the base vertically higher than the evaporation element.

7. The oven according to claim 6, wherein the entire base is vertically higher than the evaporation element.

8. The oven according to claim 6, wherein the water reservoir comprises an outlet in the base, and the outlet is vertically higher than the evaporation element.

9. The oven according to claim 1, wherein a capacity of the water reservoir is greater than a capacity of the chamber.

10. The oven according to claim 1, wherein a level of water in the chamber is the same as a level of water in the water reservoir.

11. The oven according to claim 10, wherein a minimum level of water in the water reservoir is the same as or higher than the minimum level of water in the steam generator.

12. The oven according to claim 10, wherein a maximum level of water in the water reservoir is the same as or less than a maximum level of water in the steam generator.

13. The oven according to claim 1 and further comprising a temperature sensor in the steam generator to sense a parameter representative of a temperature of the water in chamber.

14. The oven according to claim 13, wherein the parameter is the temperature of the water in the chamber.

15. The oven according to claim 1 and further comprising a discharge valve near an outlet of the steam generator to drain water from the chamber.

16. The oven according to claim 1 and further comprising an inlet valve near an inlet to the water reservoir to control the supply of water to the water reservoir.

17. The oven according to claim 1 and further comprising a heating system to heat the cooking cavity.

18. The oven according to claim 1, wherein the steam generator has a top defining an upper extent of the chamber, and the water reservoir has a top positioned relative to the chamber such that the water reservoir top is vertically below the steam generator top.

19. An oven comprising:
a housing defining a cooking cavity;
a steam generator having a top defining an upper extent of a chamber; and
a water reservoir having a top and in fluid communication with the chamber to supply water to the chamber and positioned relative to the chamber such that the water reservoir top is vertically below the steam generator top.

20. The oven according to claim 19, wherein a level of water in the chamber is the same as a level of water in the water reservoir.

21. The oven according to claim 19, wherein a capacity of the water reservoir is greater than a capacity of the chamber.
